(19) United States
(12) Patent Application Publication
(10) Pub. No.: US 2021/0154798 A1
(43) Pub. Date: May 27, 2021

(54) Machine Tool And Method Of Operating A Machine Tool

(71) Applicant: Ivoclar Vivadent AG, Schaan (LI)

(72) Inventors: Martin Huber, Pfarrwerfen (AT); Alfons Wörmer, Bischofshofen (AT)

(21) Appl. No.: 16/950,235

(22) Filed: Nov. 17, 2020

(30) Foreign Application Priority Data
Nov. 22, 2019 (EP) 19210905.6

(51) Int. Cl. B24B 49/16; B24B 27/00; B24B 49/00; B24B 49/10

(52) U.S. Cl. CPC B24B 49/16; B24B 27/0092; B24B 53/00; B24B 49/10; B24B 49/006

(57) ABSTRACT

The invention relates to a machine tool, hi particular a lathe grinding machine, comprising a tool spindle, a spindle motor and a tool clamped in a covet, with which tool a workpiece may be machined which may be moved in several axes relative to the tool, and comprising a control device for the tool spindle which controls the spindle motor. A spindle load detection device (24) which is connected with the control device (20) is provided and the control device (20) compares the output signal (26) of the spindle load detection device (24) with a predetermined threshold value (50), said threshold value (50) being below, in particular at least 20% below, the breaking load (54) of the tool (18). The control device (20) turns off the spindle motor (14) when the output signal (26) of the spindle load detection device (24) exceeds the threshold value (50).

### CROSS-REFERENCE TO RELATED APPLICATIONS

This application claims priority to European patent application No. 19210905.6 filed on Nov. 22, 2019, the disclosure of which is incorporated herein by reference in its entirety.

### TECHNICAL FIELD

The invention relates to a machine tool and to a method of operating a machine tool, in particular for the dental field.

### BACKGROUND

Machine tools including lathe grinding machines have been known for a long time.

Particularly with machine tools it is known to control the speed of a spindle motor via a control device, which is connected with the spindle motor. For this purpose, the speed is typically monitored by a motor speed sensor, and is e.g., readjusted depending on the load via a PID controller configured in the control device.

In this connection, the regulation is based on the idea that machine tools are typically configured with several axes, e.g., with 5 axes. The distribution of axes may be predefined to a large extent, from 5/0 to 2/3 and 0/5, corresponding to the distribution of the movement axes between workpiece mounting and tool mounting.

All drives for the axes have in common that stepper motors are used which effect relative feed of the workpiece to the tool. Now, the feed must match the speed of the tool such that the above-mentioned regulation is met.

Combination regulations have also been suggested in which the consumed motor current or the machining output of the milling machine is included in the regulation via the encoder and e.g., is to prevent overheating of the machining area by limiting the motor power. US 20180181106, 20040174130, 20170357243, 20200089191, 10599128, 10795341, 10261495, 10029340, 10807209, 7536237, 10228669, 9989957, 9483043, are directed to machining devices and are hereby incorporated by reference in their entirety.

In lathe grinding which is a combination of lathe turning, milling and grinding, the tool is clamped in a way known per se and ends in a comparatively small end radius. Regions adjacent to the end radius—or possibly the end radius itself—are used for machining. This is a special characteristic compared to commercially available milling cutters, but also lathe tools, as even in case of face cutters the load is typically distributed across a larger region, and the milling tool has a length to diameter ratio of typically considerably less than 5 to 1.

In contrast, in case of lathe grinding tools the length to diameter ratio, relative to the diameter of the tip of the tool, may amount to 10 to by all means.

Because of the small diameter, the required torque is comparatively small, but the drive speed of the spindle motor is relatively high. It may amount to e.g. 40,000 rev/min.

In case of drive speeds this high and a correspondingly unfavorable length to diameter ratio vibrations need to be considered, too, which are introduced into the tool because of the machining process and present additional stress for the tool but also affect the machining process of the workpiece.

To reduce the vibrations, the speed of the lathe grinding machine has been reduced or possibly even increased by way of trial, which is, however, unfavorable for certain reasons and additionally entails a change of the feed in all axes.

Due to the alternating load which is introduced into the lathe grinding tool corresponding vibrations may also lead to a particular load on the chuck of the spindle motor, and even to breaking of the tool.

### SUMMARY

In contrast, the invention is based on the task of providing improved operation of a machine tool which is preferably configured as a lathe grinding machine according to the claims, such that machining reliability is not affected in spite of good performance.

This task is inventively solved by independent claims. Advantageous developments may be taken from the subclaims.

When a lathe grinding tool breaks, the workpiece is typically also destroyed likewise, and due to the enormous centrifugal forces at 40,000 rev/min even surrounding regions are possibly also affected.

According to the invention, it is provided to install a spindle load detection device in the lathe grinding machine. It detects the current spindle load, respectively. When the spindle load exceeds a predetermined threshold value, the lathe grinding machine is turned off as a precaution. Surprisingly, this comparatively simple measure makes it possible to combine safe operation without broken lathe grinding tools flying around with high efficiency. The tool can be operated closer to the maximum and if vibrations occur, the spindle load increases due to the additional friction such that the control device turns off the spindle motor by way of precaution.

Tests have shown that the inventive measures make it possible to realize a substantially longer service life of the tool at a higher workpiece output.

The lathe grinding machine is monitored permanently according to the invention by the control device obtaining measurement values a plurality of times per second via the spindle load detection device. The spindle load detection device may e.g., have a current pick-up which detects the current motor current of the spindle motor e.g., every millisecond. Due to this high detection frequency the possibility of detecting the measurement value even more frequently than with every revolution of the spindle motor arises. In this respect, the motor current is detected selectively for different angles of rotation of the tool, respectively.

In an advantageous configuration it is provided to form a mean value over a plurality of measurement values and to then feed this mean value to the control device as an output signal.

Alternatively, the measurement values may also be fed to the control device which then form the output signal of the detection device, and the control device determines the mean values.

Preferably, the measurement cycle is relatively prime to the revolution of the spindle motor. This ensures that measurements are taken at always different angles of rotation such that a possible imbalance of the tool which is then reflected in an increased selective motor current at the position of contact of the imbalance with the workpiece is detected.

A correspondingly fast computer in the control device may also indicate the angular position of the imbalance while at the same time detecting the speed of the spindle motor.

According to the invention it is important that the spindle load is detected permanently within a temporally central period of the machining progress and when a predetermined threshold value is exceeded which is considerably, e.g., 20% or even 40%, below the breaking load, the machining process is aborted.

In this state, the tool has not broken yet but would break if the machining process was continued without stopping.

The inventive measure has the advantage that the tool may then be replaced easily by a new tool and the machining process may be continued without the workpiece having to be discarded.

Typically, a high spindle load occurs between workpiece and tool.

Depending on the workpiece this also holds true for the end of the machining process.

If, for instance, an anterior tooth crown is lathe ground, toward the end of the machining process, when the lathe grinding tool is plunged, a high wrap angle is produced and an accordingly high load.

According to the invention, it is thus preferred to carry out monitoring only between 10% and 90% of the machining progress.

Of course, these values may be adapted to the individual workpieces and the machining processes to be carried out.

The spindle load shall be defined compared to the “standard” or “normal” spindle load, which is actually a current measured by the sensor of the spindle load detection device. That means that the spindle load is detected or predetermined for specific machine and/or material/tool types.

And if the spindle load is less than the above mentioned “standard” (average) spindle load the feed is increased. Contrary to this, if the spindle load is higher than the above mentioned “standard” (average) spindle load the feed is decreased.

When a corresponding anterior tooth crown is milled or lathe ground, the crown is typically milled on the outside initially. During this machining section the spindle load is comparatively high. The inventive shutdown when the spindle load is exceeded takes effect.

In a second section, the anterior tooth crown is milled or possibly lathe ground on the inside. In this state the spindle load is considerably lower and slightly above a base line which corresponds to the current pick-up in idle mode.

In a third section, finish milling is carried out. In this section the spindle load is also considerably lower.

It is possible to turn on the inventive spindle load detection device also during the second and third section. It is also possible to reduce the threshold value for these sections.

The mentioned threshold values may be set depending on the tool wherein it is possible to encode the tool in advance and to indicate e.g., by optical detection of the code to the machine tool which threshold value is to be used.

According to the invention, the base line of the current consumption is initially determined for every machine tool. Then, the mentioned threshold value is the difference between the base line and the breaking load value, such as for example, 20%, or whatever is taken as a threshold value, as this difference corresponds to the actual load. This depends on the tool and may be not limited to 20%, but may be 10%, 30% or what is preferable for the specific tool.

In an advantageous configuration of the invention, it is provided to realize the feed of the axes of the machine tool depending on the load.

For this purpose, too, the inventive spindle load detection device may be used. It is favorable when the feed is selected to be large for a small load, and when the feed is selected to be small for a large load.

As a result, workpiece and tool are heated uniformly and no temperature peaks occur.

Such a dynamic feed control also allows for reduction of the noise emission of the machine tool and also for improvement of the machining cycle.

It is preferable that the control device compares an output signal of the spindle load detection device with a predetermined threshold value, said threshold value being below the breaking load of the tool, and that the control device turns off the spindle motor when the output signal of the spindle load detection device exceeds the threshold value.

It is preferable that the spindle load detection device comprises a current sensor for detecting current through the spindle motor and that the current sensor is connected to the control device.

It is preferable that the control device comprises a shutdown device which works based on the output signal of the spindle load detection device and is turned on subsequent to the start of machining of a workpiece and is turned off before the end of machining of the workpiece.

It is preferable that the control device keeps the speed of the spindle motor constant during machining.

It is preferable that the threshold value is at least 20% above the spindle load of a machining process comprising machining of the workpiece by lathe grinding or milling of a workpiece.

It is preferable that the control device suppresses forwarding of the output signal of the spindle load detection device at the start and at the end of the machining process.

It is preferable that the spindle load detection device outputs an output signal before the machining process and that the control device interprets the value of this output signal as a base load output signal and that the comparison with the threshold value is based on the difference between the base load output signal and the current output signal, respectively.

It is preferable that the detection device detects the current through the spindle motor more than 100 times per second or more than 500 times per second and outputs measurement values, and that the control device interpolates a plurality of measurement values of the output signal to obtain the output signal.

It is preferable that the detection device detects the current through the spindle motor between 750 and 2000 times per second.

It is preferable that the number of measurement values of the output signal used for interpolation is between 200 and 300.

It is preferable that the number of measurement values of the output signal used for interpolation is more than 20 or more than 100.

It is preferable that the control device stores a measured base load output signal and compares the current base load output signal with the stored base load output signal after several machining cycles and indicates bearing damage of the machine tool in case of a difference which is higher than a predetermined base load threshold value.

It is preferable that the difference is 5% or higher than a predetermined base load threshold value.

It is preferable that the machine tool comprises a feed control and controls the feed in steps per unit of time in a multi-axis way, and that the control device reduces the feed when the output signal is high in comparison to a mean value, and increases the feed when the output signal is low in comparison to a mean value.

It is preferable that the value of the output signal of the spindle load detection device is detected by the control device and additionally the speed of change of the output signal.

It is preferable that the threshold value is changed depending on the workpiece and is increased in case of narrow inner corners to be machined or produced, respectively.

It is preferable that the control device increases the threshold value during a second part of the machining process by 20 to 30% compared to the threshold value during the first part of the machining process.

It is preferable that the predetermined threshold value is at least 20% below the breaking load of the tool.

It is preferable that the threshold value is at least 50% above the spindle load of the normal machining process comprising machining of the workpiece by lathe grinding or milling of a workplace.

It is preferable that the control device suppresses forwarding of the output signal of the spindle load detection device for the first 10% of the machining time and for the last 10% of the machining time.

In a method embodiment, the machine tool is used which includes a tool spindle and a spindle motor and tool clamped in a collet and a control device for the tool spindle which controls the spindle motor. In the method, the tool machines a workpiece which is moved in several axes relative to the tool. A spindle load detection device is connected with the control device, the control device compares an output signal of the spindle load detection device with a predetermined threshold value, the threshold value being below the breaking load of the tool.

The control device turns off the spindle motor when the output signal of the spindle load detection device exceeds the threshold value.

It is preferable that the machine tool is a lathe grinding machine and that the predetermined threshold value is at least 20% below the breaking load of the tool.

### BRIEF DESCRIPTION OF THE DRAWINGS

Further advantages, details and features may be taken from the following description of several exemplary embodiments in conjunction with the drawings, in which:

FIG. 1 shows a schematic illustration of a part of an inventive lathe grinding machine as a machine tool in one embodiment;

FIG. 2 shows a diagram for illustrating the spindle load as a function of the spindle current relative to the machining progress;

FIG. 3a shows a diagram for the spindle load for an onlay to be produced;

FIG. 3b shows a diagram for the spindle load for an inlay to be produced;

FIG. 3c shows a diagram for the spindle load for a side tooth crown to be produced;

FIG. 3d shows a diagram for the spindle load for a veneer to be produced;

FIG. 4 shows an illustration of an output signal of the spindle load detection device during lathe grinding of another anterior tooth crown;

FIG. 5 shows an illustration of a diagram of the spindle current in the production of anterior tooth crowns with different machine tools; and

FIG. 6 shows a circuit diagram for a lathe grinding machine in accordance with the invention.

### DETAILED DESCRIPTION

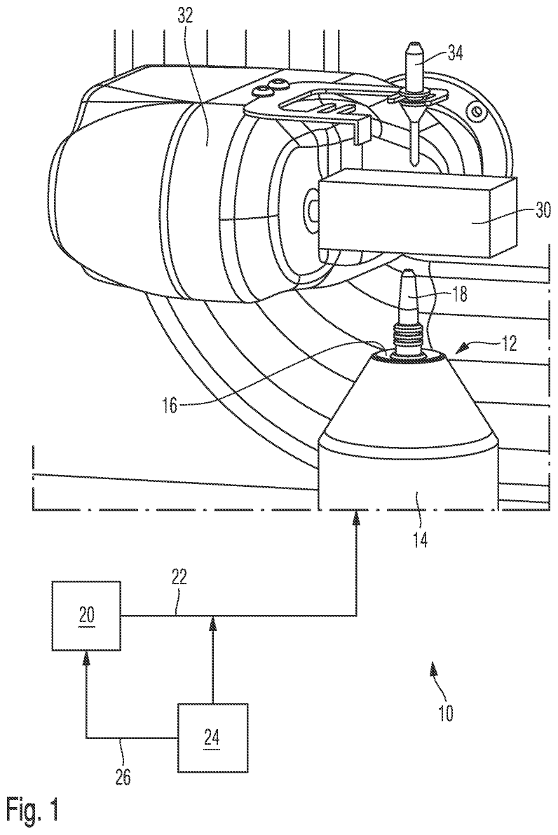

A lathe grinding machine 10 as a machine tool is apparent in parts from FIG. 1. A tool spindle 12 includes a spindle motor 14 and a tool 18 clamped in a collet 16.

In the machine tool, adjacent to the spindle motor 14, a control device 20 is provided which is illustrated schematically in FIG. 1.

The control device 20 controls the spindle motor 14 such that a spindle current 22 flows through the spindle motor 14.

The spindle current 22 is detected by a spindle load detection device 24. It comprises an output connection which supplies an output signal 26 to the control device 20.

A predetermined threshold value 50 for the spindle load or correspondingly for the spindle current 22 is stored in the control device 20. This predetermined threshold value 50 is set depending on the machine and is higher for a higher base current or idle current of the spindle motor 14 and lower for a smaller base current or a smaller idle current.

The threshold value 50 is considerably lower than a breaking load of the tool 18, namely by 25% on average in the exemplary case.

In this embodiment the threshold value 50 is changed and during most of the time of the machining progress between 10% and 80% of the machining, amounts to 30% below the breaking load of the tool 18, and between 80% and 90% of the machining progress, to 20% below the breaking load.

As is apparent from FIG. 1 the tool 18 serves to machine a workpiece 30. For this purpose, the workpiece 30 is held clamped in a robot arm 32. The robot arm 32 may be moved in 5 axes and also carries a spare tool 34.

In the illustrated exemplary embodiment, the tool spindle 12 is fixed in place such that the feed is carried out completely by the robot arm 32. It is to be understood that another axis distribution instead of 5/0 is also possible, e.g. 3/2. And the invention is not to be limited to lathe grinding either; equivalent methods may be used likewise.

As is apparent from FIG. 1, the tool 18 exhibits a slightly different shape than the tool 34. The breaking load of the tool 18 is larger than the breaking load of the tool 34.

This is taken into account by setting the predetermined threshold value 50 back in the control device 20 when the tool 18 is changed.

FIG. 1 also includes current sensor 25 located in the detection device 24 for detecting current through the spindle motor 14. The current sensor 25 is connected to the control device 20. The control device 20 also includes a shutdown device 21 in the control unit 20, which works based on the output signal 26 of the spindle load detection device 24 and is turned on subsequent to the start of machining of a workpiece and is turned off before the end of machining of the workpiece.

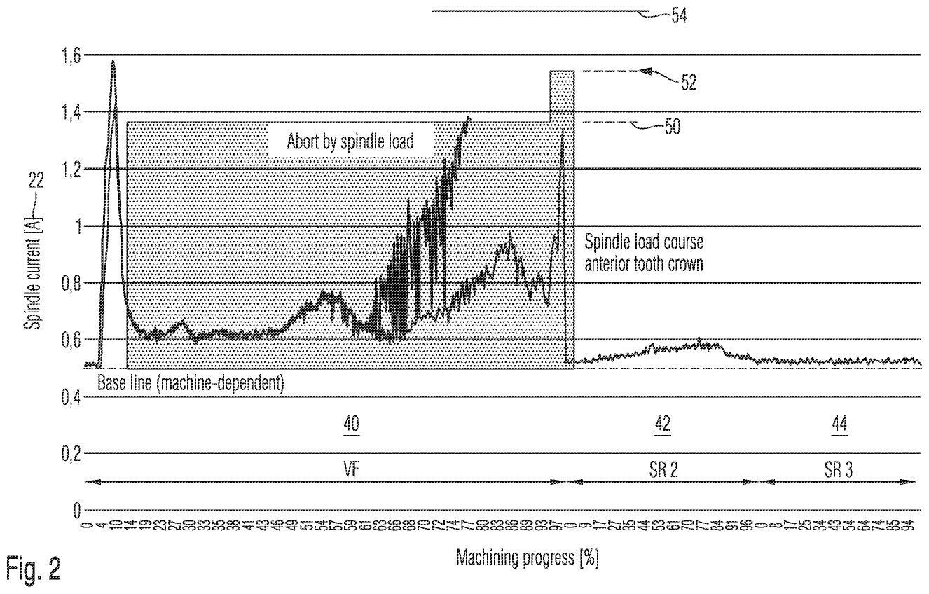

It is apparent from FIG. 2, how the spindle current 22 develops during a machining progress. The machining process takes place in three steps when the anterior tooth crown is milled.

In the first section 40 the crown is pre-milled or rough-milled.

In the second section 42 the crown is milled on the inside at a considerably lower spindle current 22.

In the third section 44 finish milling takes place; in this section the spindle current 22 is even smaller.

Every section is divided into a percentage machining progress of between 0% and 100%.

As is apparent, the spindle current 22 comprises a machine-dependent base line of approximately 500 milliamp-hours (mAh).

This spindle current 22 exists during the approximation of the workpiece 30 to the tool 18. At approximately 4% of the machining progress of section 40 the first contact between workpiece 30 and tool 18 takes place. The spindle current 22 is increased considerably; namely to approximately 1.4 ampere.

Up to the machining progress of 12%, the spindle current 22 decreased to values around 0.6 ampere, and during rough milling it increases slightly gradually.

In FIG. 2, two curves are illustrated, one is referred to as “Abort by spindle load”; and the other as “Spindle load course anterior tooth crown”.

In case of the first-mentioned curve; the spindle current 22 is increased considerably at approximately 60% of the machining progress in section 40. It rises above 1.3 ampere and then exceeds a threshold value 50 which is determined to be 1.36 ampere in the exemplary case. As soon as this threshold value 50 is reached; the milling process is aborted and a signal is output which indicates that the tool 18 needs to be replaced.

However, in this state the tool 18 has not broken yet, and accordingly the workpiece 30 has not been damaged yet either.

Even if this is not illustrated herein, the machining progress may be continued, in case of an abort at approximately 75% of the machining progress in section 40.

The spindle current 22 rises considerably again towards the end of section 40, to a value slightly below the threshold value 50. This is related to the increase of the wrap angle of the workpiece 30. In the exemplary embodiment illustrated, the threshold value 50 is increased to a threshold value 52 at approximately 95% of the machining progress. The spindle load remains below this threshold value 52.

This threshold value 52 is also considerably below a breaking load 54.

Subsequent to section 40, a further milling section 42 takes place using a smaller feed. Accordingly, the spindle current 22 is considerably lower and does not exceed 0.6 ampere.

In subsequent section 44, sole finish milling is carried out such that the spindle current 22 even remains under 0.55 ampere.

A particular advantage of the invention is that the spindle current/breaking load monitoring process prevents the workpiece 30 from being destroyed when the tool 18 breaks.

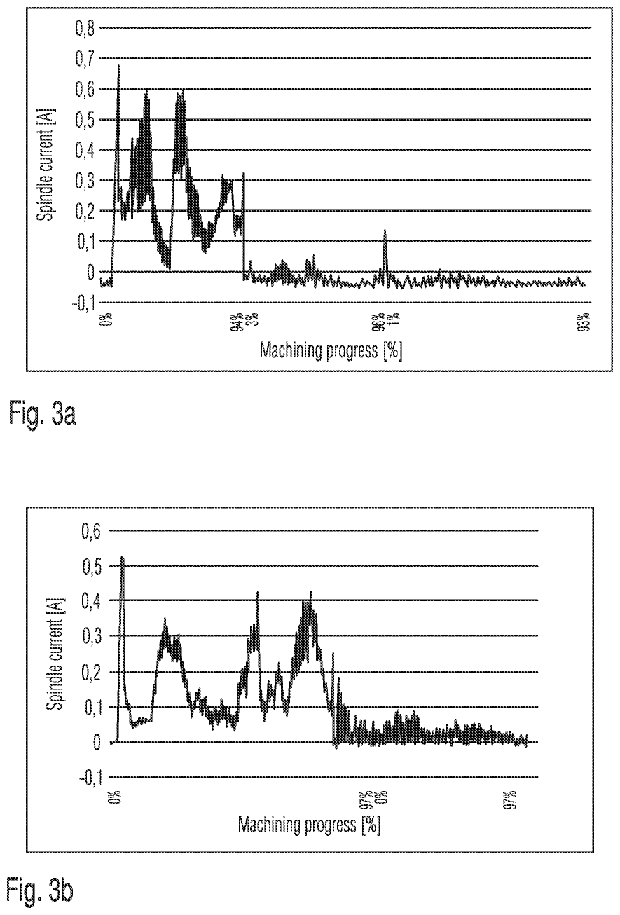

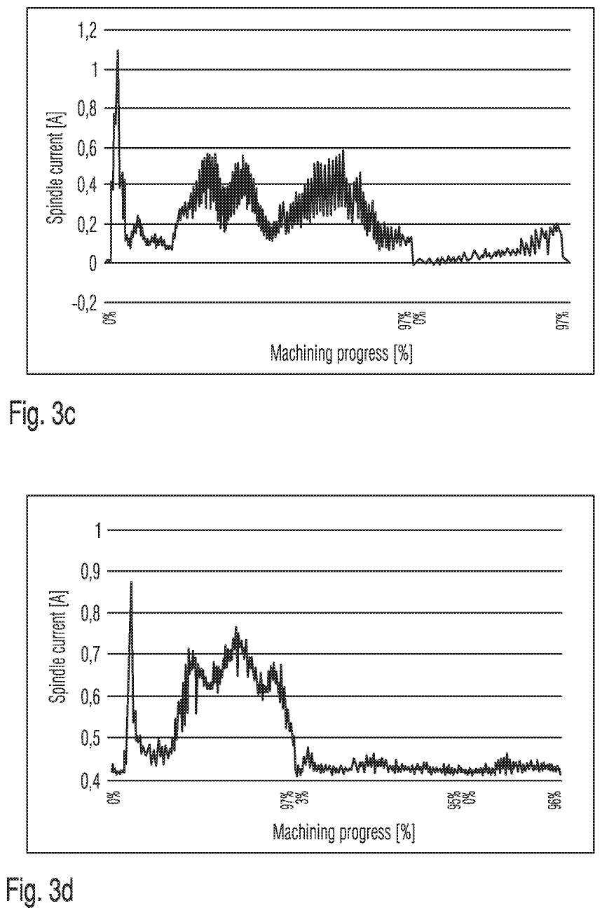

In order to clarify that different milling tasks require different spindle currents and accordingly different threshold values, other dental restoration parts to be produced are illustrated in FIGS. 3a to 3b. FIG. 3a shows the spindle current 22 for an onlay, FIG. 3b for an inlay, FIG. 3c for a side tooth crown and FIG. 3d for a veneer.

It is possible to screen different dental restorations, i.e., to detect the development of the spindle current 22 and to set the threshold value respectively depending on a typical course for the respective dental restoration part.

Additionally, the spindle current 22 is dependent on the material of the dental restoration part, but is also dependent on the tool 18 used, respectively.

By a corresponding encoding of both the workpiece 30 and the tool 18 the spindle current 22 to be expected, respectively, may be determined in advance and the threshold value 54 may be set correspondingly, wherein it is also possible to dynamically adapt the threshold value 54 as explained.

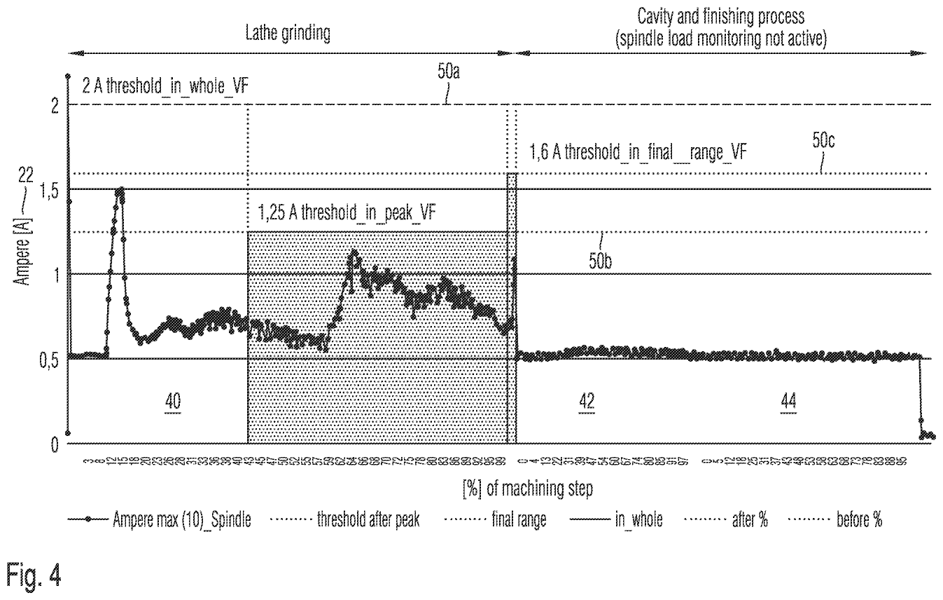

A further embodiment of an inventive diagram illustrating the spindle current 22 is apparent from FIG. 4.

The control according to FIG. 4 is characterized by a change of the threshold values. As in the embodiment according to FIG. 2, the base line or the idle current amounts to slightly more than 0.5 ampere. In section 40 rough milling or rough lathe grinding takes place. In section 40 the spindle load monitoring process is active but not in sections 42 and 44. In these sections a cavity is milled, in section 42 post-processing takes place and in section 44 finish milling.

The threshold value 50a of the spindle current 22 which must not be exceeded and holds true for the entire section 40 is 2 ampere. It applies to between 0 and 100% of the machining progress of section 40.

Bringing the workpiece 30 closer to the tool 18 takes place at approximately 10% and leads to a spindle load of approximately 1.5 ampere. This value is below the maximum threshold value 50a of section 40.

From 40% of the machining progress of section 40, a lower threshold value 50b is turned on, with 1.25 ampere. It is narrowly missed at 62% of the machining progress, the maximum value existing thereat is 1.15 ampere.

Toward the end of section 40 the threshold value is increased to a threshold value 50c which amounts to 1.6 ampere. This threshold value 50c is turned on at 96% of the machining progress and applies until 100%, i.e. until the end of section 40.

The breaking load monitoring process is turned off subsequent hereto.

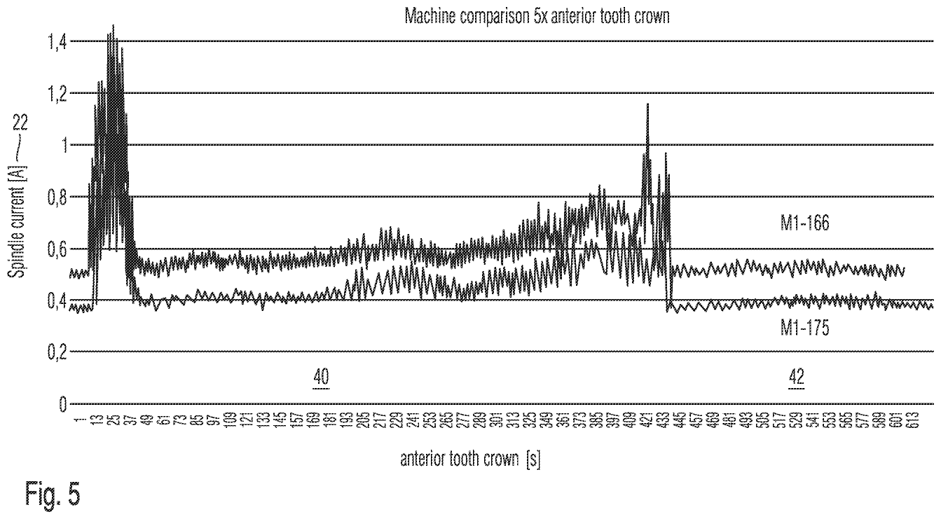

FIG. 5 shows how the spindle currents 22 differ for different machine tools. The machine tool referred to as M1-166 has an idle current of approximately 0.5 ampere, while the idle current of the machine tool referred to as M1-175 amounts to approximately 0.38 ampere and is thus considerably lower.

In lathe grinding or milling of the same workpiece 30 the spindle load curve of the machine tool M1-166 is considerably higher, respectively, than that of the machine tool M1-175 such that the threshold value must also be adapted accordingly.

The spindle load curves were produced by milling 5 anterior tooth crowns each, wherein the individual curves are superimposed, respectively, such that a slightly vague total curve results which, however, makes clear the difference between the machine tools.

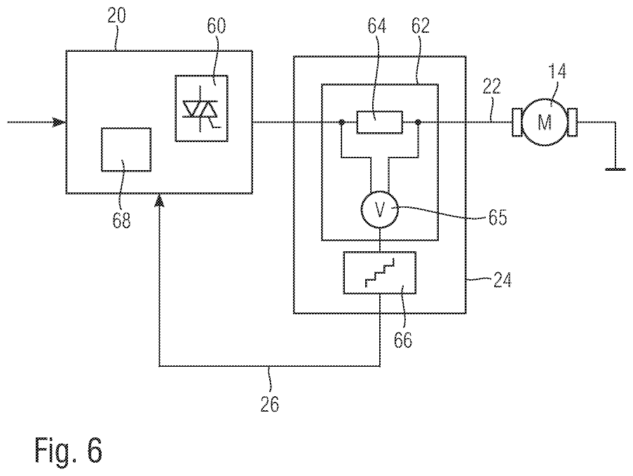

FIG. 6 shows a circuit diagram for machine tool according to the invention, in another embodiment.

According to this embodiment, the spindle load detection device 24 comprises, among others, a current sensor 62. The current sensor 62 itself comprises a small resistor 64 of e.g. 100 milliOhm, which is connected into the drive current line of the motor drive current 22.

A voltage sensor 65 senses the voltage drop over this resistor 64.

Any current sensor is possible. The basic principle is the detection of the spindle motor drive current 22.

The spindle load is not identical to the motor drive current: During acceleration there is normally no spindle load but there is a high drive current. When the spindle has reached its standard speed, the drive current 22 is—approximately—proportional to the load. “Approximately” because there are some other effects like friction and wear. Also, the motor drive characteristics usually deviate from strict linearity.

It is well known which motor is used, and tests can be performed to find out about friction and wear. Such effects may be taken into account when designing the spindle load detection device 24. For this purpose, the spindle bad detection device 24 comprise a compensation device 66 which serves to compensate for the above mentioned effects.

The motor drive current is the most important or at least an important part of spindle load detection. However, the spindle load detection device 24 offers compensation for the above mentioned side effects.

In addition, the inventive control of the spindle load is prevented or suppressed when the spindle motor 14 ramps up, thus avoiding unintentional errors caused by high start-up currents.

For this purpose, the control device 20 comprises a motor start delay control blocker 68 which blocks the shutdown control by the control device 20 for a certain time after the spindle motor 14 is switched on.

The control device 20 also comprises a shutdown device 60. This shutdown device 60 is a shut-off device for shutting down the devices connected to it, especially spindle motor 14. Any suitable shutdown device 60 can be used.

It is possible to integrate the shutdown device 60 into the control device 20 or to provide it separately.

The shut down device 60 can be realized as an immediate shutdown device. Such a device can be realized by a switch which is part of a relay. If the load is an inductive load, such as a spindle motor, high currents must be switched, which leads to known disadvantages.

Therefore, it is preferable to design the shutdown device as a controlled shutdown device 60.

With such a device, the drive current 22 is reduced in a controlled manner, according to a switch off program. The switch-off time can be adapted to the requirements, and can vary e.g. from 50 ms to 1 s.

This device is preferred because there is no “stress” in the drive train, and no sparks are generated. Such a device 60 comprises semiconductors like thyristors and/or triacs.

In one or more embodiments, the control device can be configured as a microcontroller/Programmable Logic Controller (PLC), a Proportional-Integral-Derivative (PID) controller, and so forth.

The control device can include a processor, a memory, and a communications interface. The processor provides processing functionality for the control device and can include any number of processors, micro-controllers, or other processing systems, and resident or external memory for storing data and other information accessed or generated by the control device. The processor can execute one or more software programs that implement techniques described herein. The processor is not limited by the materials from which it is formed or the processing mechanisms employed therein and, as such, can be implemented via semiconductor(s) and/or transistors (e.g., using electronic integrated circuit (IC) components), and so forth.

In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The memory is an example of tangible, computer-readable storage medium that provides storage functionality to store various data associated with operation of the control device, such as software programs and/or code segments, or other data to instruct the processor, and possibly other components of the control device, to perform the functionality described herein.

Thus, the memory can store data, such as a program of instructions for operating the system (including its components), and so forth. In embodiments of the disclosure, the memory can be integral with the processor, can comprise stand-alone memory, or can be a combination of both.

The memory can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the cable 100 and/or the memory 154 can include removable integrated circuit card (ICC) memory, such as memory provided by a subscriber identity module (SIM) card, a universal subscriber identity module (USIM) card, a universal integrated circuit card (UICC), and so on.

A communications interface can be operatively configured to communicate with components of the system. It should be noted that while the communications interface is described as a component of a control device, one or more components of the communications interface can be implemented as external components communicatively coupled to the system via a wired and/or wireless connection. The system can also comprise and/or connect to one or more input/output (I/O) devices, including, but not necessarily limited to: a display, a mouse, a touchpad, a keyboard, and so on.

1. A machine tool comprising
a tool spindle having a spindle motor and a tool clamped in a collet, with which tool a workpiece may be machined which may be moved in several axes relative to the tool, and
a control device for the tool spindle which controls the spindle motor,
wherein a spindle load detection device (24) which is connected with the control device (20) is provided,
wherein the control device (20) compares an output signal (26) of the spindle load detection device (24) with a predetermined threshold value (50), said threshold value (50) being below the breaking load (54) of the tool (18), and
wherein the control device (20) turns off the spindle motor (14) when the output signal (26) of the spindle load detection device (24) exceeds the threshold value (50).

2. The machine tool as claimed in claim 1,
wherein the spindle load detection device (24) comprises a current sensor 25 for detecting current through the spindle motor (14) and
wherein the current sensor is connected to the control device (20).

3. The machine tool as claimed in claim 1,
wherein the control device (20) comprises a shutdown device 21 which works based on the output signal (26) of the spindle load detection device (24) and is turned on or activated subsequent to the start of machining of a workpiece and is turned off before the end of machining of the workpiece.

4. The machine tool as claimed in claim 1,
wherein the control device (20) keeps the speed of the spindle motor (14) constant during machining.

5. The machine tool as claimed in claim 1,
wherein the threshold value (50) is at least 20% above the spindle load of a machining process comprising machining of the workpiece (18) by lathe grinding or milling of a workpiece (18).

6. The machine tool as claimed in claim 1,
wherein the control device (20) suppresses forwarding of the output signal (26) of the spindle load detection device (24) at the start and at the end of the machining process.

7. The machine tool as claimed in claim 1,
wherein the spindle load detection device (24) outputs an output signal (26) before the machining process, and
wherein the control device (20) interprets the value of this output signal (26) as a base load output signal and
wherein the comparison with the threshold value (50) is based on the difference between the base load output signal and the current output signal (26), respectively.

8. The machine tool as claimed in claim 1,
wherein the detection device detects the current through the spindle motor (14) more than 100 times per second or more than 500 times per second and outputs measurement values, and
wherein the control device (20) interpolates a plurality of measurement values of the output signal (26) to obtain the output signal (26).

9. The machine tool as claimed in claim 8,
wherein the number of measurements values of the output signal (26) used for interpolation is more than 20 or more than 100.

10. The machine tool as claimed in claim 1,
wherein the control device (20) stores a measured base load output signal and compares the current base load output signal with the stored base load output signal after several machining cycles and indicates bearing damage of the machine tool in case of a difference which is higher than a predetermined base load threshold value.

11. The machine tool as claimed in claim 1,
wherein the machine tool comprises a feed control and controls the feed in steps per unit of time in a multi-axis way, and
wherein the control device (20) reduces the feed when the output signal (26) is high in comparison to a mean value and increases the feed when the output signal (26) is low in comparison to a mean value.

12. The machine tool as claimed in claim 1,
wherein the value of the output signal (26) of the spindle load detection device (24) is detected by the control device (20) and additionally the speed of change of the output signal (26).

13. The machine tool as claimed in claim 1,
wherein the threshold value (50) is changed depending on the workpiece and is increased in case of narrow inner corners to be machined or produced, respectively.

14. The machine tool as claimed in claim 1,
wherein the control device (20) increases the threshold value (50) during a second part of the machining process by 20 to 30% compared to the threshold value (50) during the first part of the machining process.

15. The machine tool as claimed in claim 1,
wherein the predetermined threshold value (50) is at least 20% below the breaking load (54) of the tool (18).

16. The machine tool as claimed in claim 1,
wherein the threshold value (50) is at least 50% above the spindle load of the normal machining process comprising machining of the workpiece (18) by lathe grinding or milling of a workpiece (18).

17. The machine tool as claimed in claim 1,
wherein the control device (20) suppresses forwarding of the output signal (26) of the spindle load detection device (24) for the first 10% of the machining time and for the last 10% of the machining time.

18. The machine tool as claimed in claim 8,
wherein the detection device detects the current through the spindle motor (14) between 750 and 2000 times per second.

19. The machine tool as claimed in claim 8,
wherein the number of measurements values of the output signal (26) used for interpolation is between 200 and 300.

20. The machine tool as claimed in claim 10,
wherein the difference is 5% or higher than a predetermined base load threshold value.

21. A method of operating a machine tool, comprising a tool spindle and a spindle motor and tool clamped in a collet, which tool machines a workpiece which is moved in several axes relative to the tool, and comprising a control device for the tool spindle which controls the spindle motor, said method comprising
providing a spindle load detection device (24) connected with the control device (20),
the control device (20) compares an output signal (26) of a spindle load detection device (24) with a predetermined threshold value (50), said threshold value (50) being below, the breaking load (54) of the tool (18), and
the control device (20) turns off the spindle motor (14) when the output signal (26) of the spindle load detection device (24) exceeds the threshold value (50).

22. The method according to claim 21,
wherein the machine tool is a lathe grinding machine and
wherein the predetermined threshold value (50) is at least 20% below the breaking load (54) of the tool (18).
